(19) United States
(12) Patent Application Publication
(10) Pub. No.: US 2004/0142157 A1
(43) Pub. Date: Jul. 22, 2004

(54) Multi-component coextrusion

(76) Inventor: George Melkonian, Federal Way, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/699,253

(22) Filed: Oct. 30, 2003

Related U.S. Application Data
(63) Continuation of application No. 09/712,411, filed on Nov. 13, 2000, now abandoned.

(51) Int. Cl. B32B 3/12

(52) U.S. Cl. 428/292.1; 428/158

(57) ABSTRACT

A multi-component composite extrusion includes various combinations of a hollow, high density profile filled in with a foamed, thermoplastic core. A further low density foamed profile can alternately surround the high density, hollow component. A capstock can be provided on either embodiment of the multi-component extrusion. All of the components are preferably substantially simultaneously extruded in a single multi-plate extrusion die, so that the various components are substantially laterally coextensive with one another and molecularly bonded to the adjacent component. The thin wall, high density component and the adjacent low density foamed thermoplastic component may optionally be provided with substantial wood fiber content to alter the macroscopic properties of the resulting multi-component extrusion. The extrusion has utility in the fenestration, decking, and remodeling industries. The method disclosed for making the extrusion permits the extrusion designer to vary the type of thermoplastic material used with respect to each component and the presence or absence of wood fiber in the components to vary the macroscopic properties of the entire composite extrusion, surface characteristics of the extrusion, and weatherability of the extrusion.

### TECHNICAL FIELD

This invention relates to methods and apparatus for forming a multiple component, composite polymer/wood fiber extrusion and a method for making the same. More specifically, the invention relates to a composite extrusion of the type described above having a multiplicity of components, including a high density, substantially hollow extrusion profile having inner and/or outer components having a different density coextruded with the high density component.

### BACKGROUND OF THE INVENTION

Milled wood products have formed the foundation for the fenestration, decking and remodeling industries for many years. Historically, ponderosa pine, fir, red wood, cedar and other coniferous varieties of soft woods have been employed with respect to the manufacture of residential window frames, residential siding and outer decking. Wood products of this type inherently possess the advantageous characteristics of high flexural modulus, good screw retention, easy workability (e.g., milling, cutting, paintability), and for many years, low cost. Conversely, wood products of this type have also suffered from poor weatherability in harsh climates, potential insect infestation such as termites, and high thermal conductivity. In addition to these inherent disadvantages, virgin wood resources have become scarce, thus the raw material cost for milled wood products has become correspondingly expensive.

In response to the above described disadvantages of milled wood products, the fenestration industry, in particular, adopted polyvinyl chloride as a raw material for the manufacture of hollow, lineal extrusions for subsequent assembly into window frames. Window frames manufactured from such lineal extrusions became an enormous commercial success, particularly at the lower end of the price spectrum. Window frames manufactured from hollow, lineal polyvinyl chloride (PVC) extrusions exhibited superior thermal conductivity, water absorption resistance (and thus rot resistance), insect resistance, and ultraviolet radiation resistance compared to painted ponderosa pine. Although such extrusions further enjoyed a significant cost advantage over comparable milled wood products, these polymer based products had a significantly lower flexural modulus. (i.e., bending moment), were difficult if not impossible to paint effectively, and had a significantly higher coefficient of thermal expansion. By the mid 1990s, a number of window and door frame manufacturers attempted to combine the most desirable characteristics of extruded thermoplastic polymers and solid wood frame members by alloying PVC with wood fiber in an extruded product.

U.S. Pat. No. 5,486,553 to Deaner et al. discloses an extruded polymer/wood fiber thermoplastic composite structural member, suitable for use as a replacement for a wood structural member, such as for window frame components. The preferred thermoplastic component is polyvinyl chloride (PVC), and the preferred wood fiber component is sawdust. In a preferred embodiment of the invention, a double hung window unit is disclosed having cell, jamb and header portions comprising hollow, multi-compartment lineal extrusions which can be made from the disclosed thermoplastic polymer/wood fiber composite. The resulting extrusion has mechanical properties which are similar to wood, but have superior dimensional stability, and resistance to rot and insect damage as compared to conventional wood products.

Problems relating to co-extrusion of wood fibers and a thermoplastic polymer component are well explained in U.S. Pat. No. 5,851,469 to Muller et al. issued Dec. 22, 1998, the disclosure of which is incorporated herein by reference. Muller et al. described the typical prior art steps for co-extruding a thermoplastic polymer with wood fiber. In a first step, the wood fiber is dried using conventional techniques to a moisture content of less than 8% by weight. In a second step the wood fiber and plastic material are preheated to a temperature of approximately 176° F. to 320° F. In a third step, the materials are mixed or kneaded at a temperature of 248° F. to 482° F. to form a paste. In a fourth and final step, the paste is either injection molded or extruded into a final form. If the paste is extruded, the extrudate must be calibrated and cooled. The Muller et al. reference specifically addresses the problem of controlling the temperature of the extrudate through various stages of the extrusion process to prevent undesirable sheer stresses from arising during the extrusion process. Muller et al. also teach that a particular problem involved with wood fiber/thermoplastic composite extrudates involves volatiles in the wood component boiling off at extrusion temperatures causing an undesirable foaming of the extrudate.

In addition, extruded polymer/wood thermoplastic composite structural members allowed manufacturers to limit the amount of expensive thermoplastic materials used in the extrusion by increasing the percentage of low cost waste wood product incorporated into the process. Substantial advancements have been made in this art whereas as of the filing date of this application, concentrations of wood fiber in a hollow core, thermoplastic extrusion up to 30 to 40 percent are known. Unfortunately, adding significant quantities of wood fiber to the thermoplastic polymer/wood fiber composite degrades the flexural modulus (i.e., bending moment) of the extrusion. Thus, manufacturers often resort to the use of U-shaped metal channels which reside inside hollow sections of the longitudinal extrusion to provide increased stiffness, as well as angled metal members incorporated into interior components of such structures and corners thereof. The use of such additional structural members disadvantageously increases the cost of assembling products of this type, as well as decreases the thermal efficiency of these products.

Some manufacturers have moved in a different direction by preparing foamed lineal extrusions, with and without a wood fiber content. Such extrusions address the difficulties in connecting thin wall, hollow extrusions at corners (typically done by thermal welding) by providing a large surface area for joining. In addition, screw retention and thermal efficiency may be substantially improved in foamed extrusions of this type. Further yet, foamed extrusions containing a high wood fiber content are readily paintable and can be provided with a surface texture which mimics solid wood. The assignee of the present invention has developed improved techniques for increasing the wood fiber content of such foamed extrusions as disclosed in U.S. patent application Ser. No. 09/452,906, entitled “Wood Fiber Polymer Composite Extrusion and Method”, filed Dec. 1, 1999, the disclosure of which is incorporated herein by reference. Unfortunately, while such foamed lineal extrusions advantageously exhibit improved heat deflection, Vicat softening point, screw retention, and lower density (i.e., decreased raw material cost) as opposed to rigid, hollow core PVC extrusions, foamed extrudates typically have a lower flexural modulus than comparable rigid, thin walled, hollow core PVC extrusions.

In an attempt to combine the specific structural advantages of different types of polymers, at least one manufacturer in the fenestration industry has attempted to produce a multi-component extrusion having an extruded foamed material as one component, flexible flanges as another component, and a partial capstock as a third component. An example of an extrusion of this type is disclosed in U.S. Pat. No. 5,538,777 to Pauley et al. entitled “Triple Extruded Frame. Profiles”, issued Jul. 23, 1996. That patent discloses a three-component extrusion for a window sash. The main component of the extrusion in cross-section is a polyvinyl chloride foam core, optionally including a fiber component. The core has a recess forming a U-shaped channel for receipt of glass panes. The panes are held in place by flexible flanges extending normal to the inside of the channel in the form of a flexible material which is used to form the flexible flanges and/or seals. Dupont Alcryn™ is disclosed as an appropriate material for the flanges. The extrusion is also disclosed as having a partial capstock, preferably acrylic styrene acrylonitrile (ASA) which is provided only on the portion of the exterior of the extrusion which will be exposed to weathering. Although this extrusion enjoys the low cost advantages of a foamed, thermoplastic/wood fiber core and the weatherability of a partial capstock, it is believed that an extrusion of this type has insufficient flexural modulus for use in anything other than as a sash portion of a window assembly. That is, it is believed that metallic channel stiffeners, and the like, would still be necessary if this type of extrusion construction was employed as a main frame element.

Thus, a need exists for a lineal extrusion for use in the fenestration, decking and remodeling industries which combines a low raw material cost with high tensile, compressive, bending moment, and impact strength; improved weldability with respect to hollow core extrusions; high wood fiber content (reduced cost); and high workability (e.g., millable, paintable, and good screw retention). In addition, there is a need for an extrusion of the type described above which is highly durable, being-resistant to rot, mildew, and ultraviolet degradation.

### SUMMARY OF THE INVENTION

It is therefore an object of the present invention to provide a continuous, lineal multi-component polymer composite extrusion having low raw material cost; high tensile, compressive, bending moment, and impact strength; improved weldability with respect to hollow core extrusions; high wood fiber content; and high workability.

It is a further object of the present invention to achieve the above object by a method and apparatus which provides a continuous, lineal multi-component polymer composite extrusion which is highly durable, being resistant to rot, mildew, and ultraviolet degradation.

It is yet a further object of the invention to achieve the above objects with a manufacturing process capable of varying the ultimate macroscopic properties of the resulting extrudate so as to closely match the differing physical requirements of the fenestration, decking and siding markets.

The invention achieves the above objects and advantages, and other objects and advantages which will become apparent from the description which follows, by providing a multi-component, longitudinally continuous extrusion having a first, high density, thin wall composite member having a thermoplastic component and a cellulosic fiber component. The inventive extrusion further has a second, low density foamed member, consisting of a foamed, thermoplastic polymer coextruded with the first member in a plastic state, substantially contemporaneously with the first member, in an extrusion die so as to be laterally coextensive with, and molecularly bonded to, either an inside hollow portion of the first, thin wall high density member, an outside of the first, thin wall, high density member, or both.

In the preferred embodiment, the inventive extrusion may be capped with a thin layer of acrylic styrene acrylonitrile (ASA) or polyvinyl chloride (PVC).

In alternate embodiments of the invention, the low density foamed member may include a substantial wood fiber content, particularly when the second, low density foamed member is on the outside of the first, thin wall, high density composite member and a thermoplastic cap is not employed. The thermoplastic cap may be provided with a highly weatherable, thermoplastic polymer on one side of the extrusion (to be exposed to the outdoor portion of a building) and a highly paintable thermoplastic polymer on an opposite side of the extrusion, to be exposed to an indoor portion of the building.

The invention includes apparatus in the form of a multi-plate extrusion die for manufacturing the above extrusions, including an introductory plate for passage therethrough of a primary extrudate from a principal extruder, a mandrel plate downstream of the introductory plate for receipt of the primary extrudate which will become the first, thin wall, high density composite member. The mandrel plate has suspended within an aperture therein a first elongated mandrel wherein the first mandrel is substantially hollow and has therein a second mandrel substantially suspended therein in a spaced apart relationship from the side walls of the first elongated mandrel so as to form an elongated, hollow interstitial void between the first and second mandrels. The interstitial void is thus available for introduction of the second, low density foamed material which can become laterally coextensive with, and molecularly bonded to, one of the inner side walls of the first member. Finally, a secondary plate is positioned between the introductory and mandrel plates so that in one alternate, preferred embodiment of the invention the second, low density foamed extrudate can be provided on the outer side wall of the first, thin wall, high density composite member so that foamed material can be provided on both the inside and the outside of the thin wall extrusion, as well as on the inside or the outside of the hollow core extrusion exclusively. A capstock plate can be provided downstream of the mandrel plate for adding a third extrudate in the form of a capstock to the final extrudate. Elongated, tapered fins are preferably provided to support the first elongated mandrel with respect to the aperture in the mandrel and also to support the second mandrel in a spaced apart relationship with respect to inner side walls of the first hollow mandrel.

The invention includes a method of making the above described multi-component, longitudinally continuous extrusion with the above described introductory, mandrel, and secondary die plates which includes the steps of preparing a thermoplastic primary extrudate and a secondary thermoplastic extrudate, introducing the primary extrudate in a plastic state into the introductory plate, positioning a mandrel plate downstream of the introductory plate, and introducing the secondary extrudate in a plastic state into a void between the first and second, coaxially spaced mandrels in the mandrel plate, so that an elongated final extrudate having at least two different longitudinally continuous, molecularly bonded thermoplastic components exit the mandrel plate.

### BRIEF DESCRIPTION OF THE DRAWINGS

FIG. 1 is an environmental view of a first embodiment of a multi-component, polymer composite extrusion of the present invention.

FIG. 2 is a an exploded schematic representation of a plurality of extrusion die plates employed in the manufacture of the extrusion shown in FIG. 1.

FIG. 3 is a left hand, environmental view of a mandrel plate die of the die shown in FIG. 2.

FIG. 4a is a right hand perspective view of the mandrel plate die shown in FIG. 3.

FIG. 4b is a left hand perspective view of a floating mandrel of the mandrel die shown in FIG. 4a.

FIG. 4c is a right hand perspective view of the floating mandrel shown in the mandrel die of FIG. 4a.

FIG. 5 is a schematic representation of a polymer flow in a plastic state in the die assembly shown in FIG. 2.

FIG. 6 is an environmental view of a second embodiment of a multi-component, polymer composite extrusion of the present invention.

FIG. 7a is a right hand, perspective view of a mandrel plate having a dual floating mandrel therein for manufacture of the extrudate shown in FIG. 6 in conjunction with some of the die plates shown in the die plate assembly of FIG. 2.

FIG. 7b is a left hand environmental view of a mandrel plate having a dual floating mandrel therein for manufacture of the extrudate shown in FIG. 6 in conjunction with some of the die plates shown in the die plate assembly of FIG. 2.

FIG. 8a is an enlarged, right hand perspective view of the dual floating mandrel shown in FIG. 7a.

FIG. 8b is a left hand perspective view of the dual floating mandrel shown in corresponding FIG. 7b.

FIG. 9 is a schematic representation of a third alternate embodiment of the invention.

### DETAILED DESCRIPTION OF THE PREFERRED EMBODIMENTS

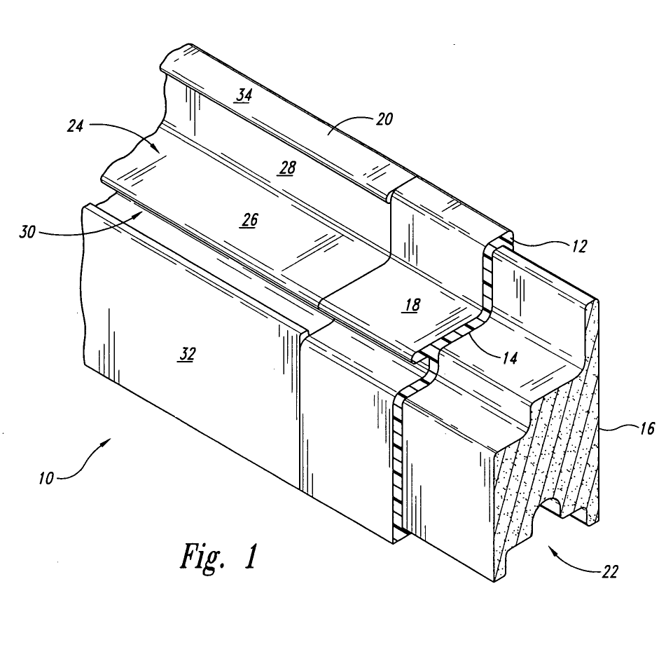

A first preferred embodiment of a multi-component, composite polymer/wood fiber continuous lineal extrusion of the present invention is generally indicated at reference numeral 10 of FIG. 1. The extrusion includes a first, high density, thin wall component 12, having an inner side wall 14 defining at least one hollow section in profile. The multi-component extrusion 10 further has a second, low density foamed thermoplastic member 16 which is coextruded with, and substantially fills, the hollow section defined by inner side wall 14. As will be described in further detail hereinbelow, the second component 16 is preferably formed of a foamed thermoplastic member which is molecularly bonded to, and substantially laterally coextensive with, the inner sidewall 14. In this preferred embodiment, the first component 12 has an outer side wall 18 defining the exterior surface of the first component. In this first preferred embodiment, the outer side wall 18 supports a thermoplastic cap 20 which is substantially coextruded with the first and second components 12, 14, so as to be molecularly bonded to the outer side wall 18. The thermoplastic cap is preferably formed from a highly weatherable, thermoplastic polymer such as polyvinyl chloride (PVC).

The multi-component, composite polymer/wood fiber extrusion 10 shown in FIG. 1 is suitable for use as vertical and horizontal members of a window sash. The extrusion defines a substantially U-shaped channel, generally indicated at reference numeral 22, for the receipt of weatherstripping material, and the like (not shown). The extrusion 10 shown in FIG. 1 also has on the upper portion thereof a substantially L-shaped surface 24, having a lower ledge 26 and at right angles thereto a vertical edge 28. When assembled into a window sash, the extrusion 10 is cut into four desired lengths, having each end of each section mitered at an appropriate angle. The mitered edges are then thermally welded in a manner well known to those of ordinary skill in the art so as to form a complete sash frame. Extrusion 10 of the present invention advantageously presents a cross-section at each miter joint having a substantially continuous surface of thermoplastic material. Thus, the entire cross-sectional surface area available for thermal welding is substantially greater than that of a continuous lineal extrusion being substantially hollow in profile. In addition, it is relatively easy to align adjacent members of the sash because of the large, surface area available for welding.

In the context of a complete sash structure, the lower edge 26 of the extrusion 10 is well adapted to receive edges of glass panes (not shown) in a moveable or fixed sash. Vertical edge 28 provides a support surface for a rearward pane member of, for example, a double-pane sash. The extrusion 10 is also provided on a forward edge thereof with a bead pocket, generally indicated at reference numeral 30, for receipt of a bead (not shown) for retaining an outer pane of a double pane window sash. Thus, the completed sash defines an exterior surface 32 for the sash and an interior surface 34. In this embodiment, the exterior surface 32 is exposed to weathering, while the interior surface 34 [extending from the vertical edge 28 around the rear (hidden in FIG. 1) surface of the thermoplastic cap 20] is exposed to the interior of a home or the like. The thermoplastic cap 20 may therefore be preferably provided with the interior surface 34 being extruded from a thermoplastic polymer that is highly paintable, whereas the exterior surface 32 is extruded with a thermoplastic polymer that is highly weatherable.

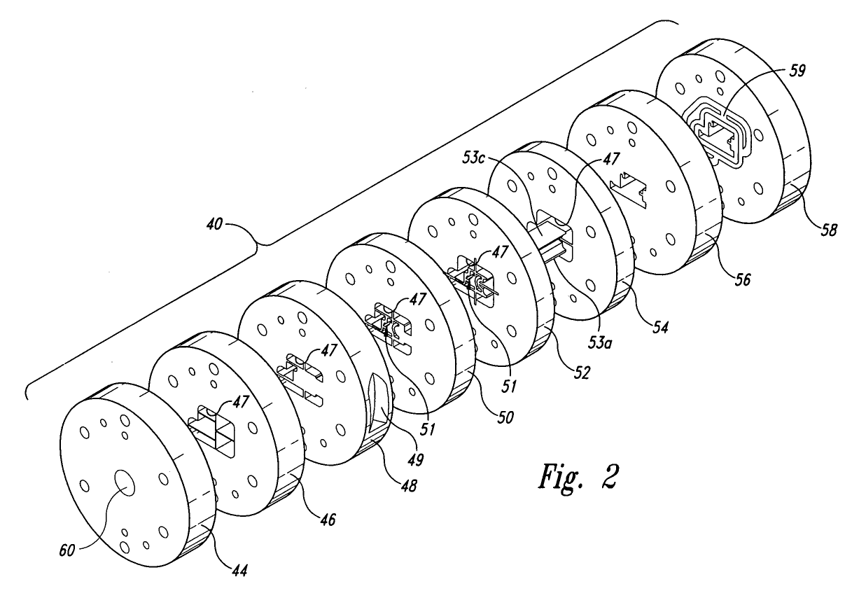

FIG. 2 illustrates a die assembly 40 consisting of a series of individual die plates, 44, 46, 48, 50, 52, 54, 56, and 58, for manufacturing the multi-component extrusion 10 shown in FIG. 1. The manner of use of such dies is well known to those of ordinary skill in the thermoplastic extrusion art and is well described in U.S. patent application Ser. No. 09/452,906, entitled “Wood Fiber Polymer Composite Extrusion and Method” assigned to the assignee of the present invention. Disclosure of that application is incorporated herein by reference. Nevertheless, it is sufficient to state that the die assembly 40 shown in FIG. 2 is intended for use with a plurality of conventional extruders, such as conventional twin screw extruders, each of which includes a hopper or mixer for accepting a feed stock consisting of a thermoplastic polymer and/or wood composite pelletized material, a conduit for connecting the hopper with a preheater for controlling the temperature of an admixture of the feed stock in the hopper, and optionally an inlet for introducing foaming agents in the case of a foamed component. The preheater is fluidly connected to a multi-screw chamber for admixing feedstock with the foaming agent (if present) and other conditioners to be described hereinbelow under controlled conditions of temperature and pressure. The multi-screw chamber of each extruder is connected to an appropriate one of the die assembly plates shown in FIG. 2 for producing the multi-component extrusion 10 shown in FIG. 1. The extrudate is then preferably calibrated in a conventional calibrator to result in a final product shown in FIG. 1. Appropriate extruding machines are available from Cincinnati Millacron Corporation, Batavia, Ohio, USA.

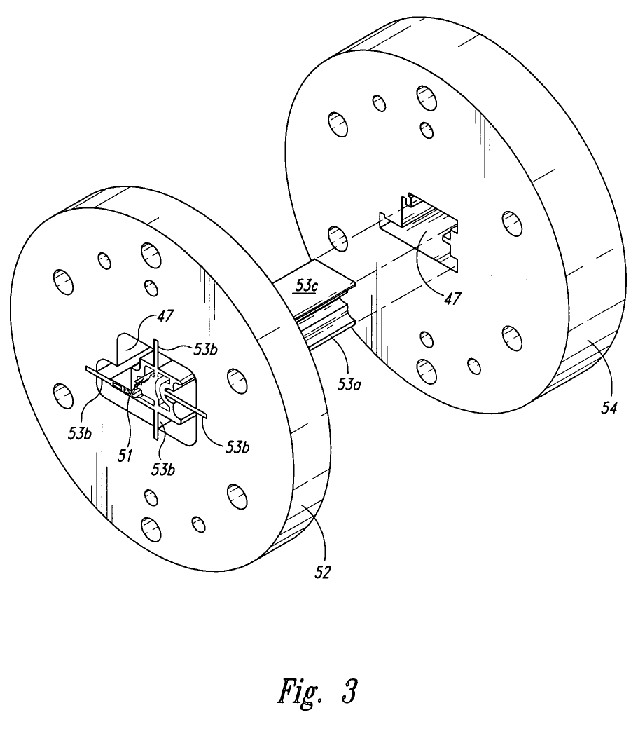

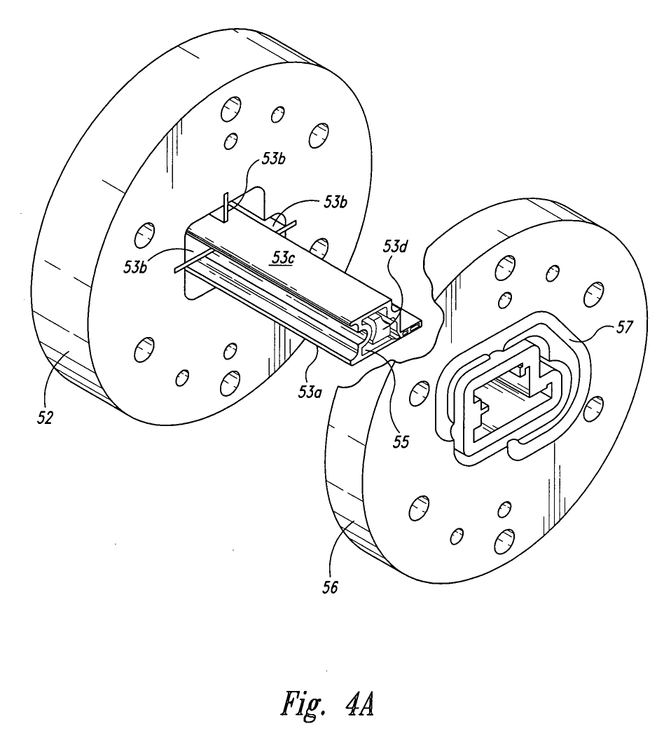

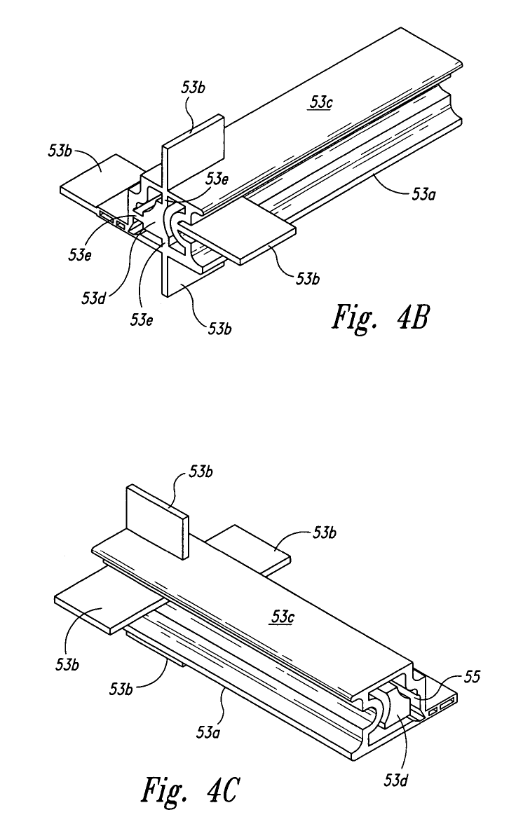

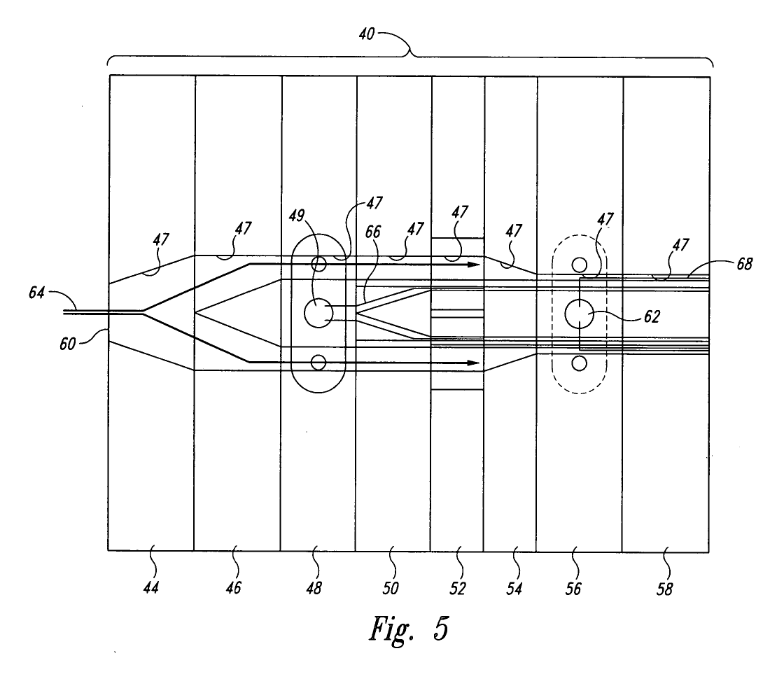

As best seen in FIG. 2, one of the hereinabove described extruders (not shown) is fluidly connected to an introductory plate 44 for introduction of a primary extrudate which will become the hollow high density component 12 shown in FIG. 1. The primary extrudate is introduced through a primary aperture 60 in the introductory plate 44. A first shaping plate 46 has a plurality of internal conduits 47 for directing the flow of the primary extrudate to corresponding conduits in a secondary extrudate die plate 48. Secondary extrudate die plate 48 has an inlet 49 for introduction of a secondary extrudate which will become the second, low density foamed thermoplastic component 16 of the extrusion shown in FIG. 1. The inlet 49 is fluidly connected to a secondary shaping die plate 50 by way of an internal secondary conduit 51. Both the internal primary and secondary conduits 47, 51 are in fluid communication with a mandrel plate 52 which supports a first mandrel 53(a) by means of a plurality of longitudinally elongated fins 53(b) within the internal primary conduit 47. An external surface 53(c) of the first mandrel 53(a) is the inner forming surface for the primary extrudate. As best seen in FIGS. 3 & 4(a)-4(c), the first mandrel 53(a) is substantially hollow and has suspended therein a second mandrel 53(d). The second mandrel 53(d) is suspended within the hollow interior of the first mandrel 53(a) by elongated, longitudinally tapering fins 53(e). Thus, the first and second mandrels 53 (a) and 53(d) form a two-stage floating mandrel within the internal primary conduit 47. The secondary extrudate which will ultimately comprise the second, low density foamed thermoplastic component 16 of the multi-component extrusion 10 of FIG. 1 enters the die assembly 40 of FIG. 2 through the secondary extrudate inlet 49, the internal secondary conduit 51, and then the voids formed between the first and second mandrels. A mandrel shaping plate 54 is positioned adjacent to the mandrel plate 52 and is in fluid communication therewith for further shaping the principal extrudate about the external surface 53(c) of the first mandrel 53(a). The tapering fins 53(e) taper in thickness from the maximum thickness shown in FIG. 4b to a thin edge (hidden from view) approximately one-quarter of the length of the first and second mandrels in a manner well known to those of ordinary skill in the art so that at the exit end of the first and second mandrels the fins end and are absent from the void 55. The die assembly 40 further includes first and second capstocking dies 56, 58, having corresponding first and second internal channels 57, 59 for introduction of a third extrudate in the form of a capstock from a third extruder (not shown) through capstocking inlet 62 in first capstock die 56, as best seen in FIG. 5.

FIG. 5 is a schematic representation of extrudate flow through die assembly 40, illustrating flow of the primary extrudate 64, the secondary extrudate 66, and the third extrudate 68. As stated above, the primary extrudate forms the thin wall, high density, hollow component 12; the secondary extrudate forms the second, low density foamed thermoplastic component 16; and the third extrudate forms the thermoplastic cap 20 of the extrusion 10 shown in FIG. 1.

Table 1 hereinbelow illustrates one preferred formulation used for the principal extrudate used in the production of the thin wall, high density hollow component 12, shown in FIG. 1. In this preferred embodiment, the thin wall, high density hollow component 12 consists of a polyvinyl chloride (PVC)/wood flour composite. The inclusion of wood flour is preferred, but nevertheless is optional.

TABLE 1
PVC/Wood Flour Composite

| INGREDIENT | PERCENT | SUPPLIER | CITY | STATE |
|---|---|---|---|---|
| PVC resin | 50.25 | Shintech | Freeport | Texas |
| Stabilizer | 0.75 | Witco | Taft | Louisiana |
| Plasticizer | 1.51 | Kalama | Kalama | Washington |
| Process Aid | 1.96 | Struktol | Stow | Ohio |
| TR-060 | | | | |
| Lubricant | 0.50 | Morton | Cincinnati | Ohio |
| PCS-351E | | | | |
| Modifier | 5.03 | GE | Morgantown | West |
| B-360 | | | | Virginia |
| Wood Flour | 40.00 | American | Schofield | Wisconsin |
| (60 Mesh | | Wood | | |
| Pine) | | Fiber | | |

The secondary extrudate 66 which forms the second, low density foamed thermoplastic component 16 in the preferred embodiment shown in FIG. 1 consists of a polyvinyl chloride (PVC) foamed core. Table II illustrates one preferred formulation of the secondary extrudate 66.

TABLE II
PVC Foam Core

| INGREDIENT | PERCENT | SUPPLIER | CITY | STATE |
|---|---|---|---|---|
| PVC resin SE 650 | 77.97 | Shintech | Freeport | Texas |
| Stablizer | 1.25 | Witco | Taft | Louisiana |
| MK 1915 | | | | |
| Lubricant | 1.55 | Cognis | Kanakee | Illinois |
| VGE-1875 | | | | |
| Calcium | 0.39 | Synpro | Cleveland | Ohio |
| Stearate | | | | |
| Lubricant | 0.12 | Cognis | Kanakee | Illinois |
| AC-629A | | | | |
| Modifier | 4.68 | Kaneka | Pasadena | Texas |
| PA-40 | | | | |
| Titanium | 0.78 | Huntsman | Lake | Louisiana |
| Dioxide | | Tioxide | Charles | |
| Filler UFT | 2.34 | OMYA | Florence | Vermont |
| Foaming | 9.36 | Clariant | Charlotte | North |
| Agent | | | | |
| Hydrocerol | | | | |
| Process Aid | 1.56 | Struktol | Stow | Ohio |
| TR-060 | | | | |

A preferred formulation used for the third extrudate 68, forming the thermoplastic cap 20 in the multi-component extrusion 10 of FIG. 1, is illustrated in Table III, wherein the thermoplastic has favorable weatherability characteristics.

TABLE III
PVC Cap

| INGREDIENT | PERCENT | SUPPLIER | CITY | STATE |
|---|---|---|---|---|
| PVC Resin | 76.161 | Shintech | Freeport | Texas |
| SE-650 | | | | |
| Stabilizer | 0.610 | Witco | Taft | Louisiana |
| 401P | 0.228 | PQ Corp. | Kansas City | Kansas |
| Lubricant | 2.44 | Cognis | Kanakee | Illinois |
| VGE-3041 | | | | |
| Anti-stat | 0.38 | Clariant | | Germany |
| Modifier K- | 4.95 | Kaneka | Pasadena | Texas |
| 37 | | | | |
| Calcium | 3.04 | OMYA | Florence | Vermont |
| Carbonate | | | | |
| TiO2 | 7.62 | Huntsman | Lake | Louisiana |
| | | Tioxide | Charles | |
| Calcined | 4.57 | Burgess | Sanders- | Georgia |
| Clay | | | ville | |

Alternatively, thermoplastic component 20 may be provided by an alternate formulation of the third extrudate 68 in the form of a highly paintable thermoplastic cap 20. A preferred extrudate formulation is illustrated in Table IV, wherein the principal ingredients of that extrudate are Styrene Acrylonitrile (SAN) and Acrylic Styrene Acrylonitrile (ASA).

TABLE IV
ASA Cap

| INGREDIENT | PERCENT | SUPPLIER | CITY | STATE |
|---|---|---|---|---|
| SAN B-578 | 69.125 | GE | Morgantown | West |
| | | | | Virginia |
| ASA B-984 | 29.625 | GE | Morgantown | West |
| | | | | Virginia |
| EBS Advawax 280 | 0.50 | Morton | Cincinnati | Ohio |
| Calcium | 0.50 | Synpro | Cleveland | Ohio |
| Stearate | | | | |
| UV Absorber | 0.25 | GE | Morgantown | West |
| | | | | Virginia |

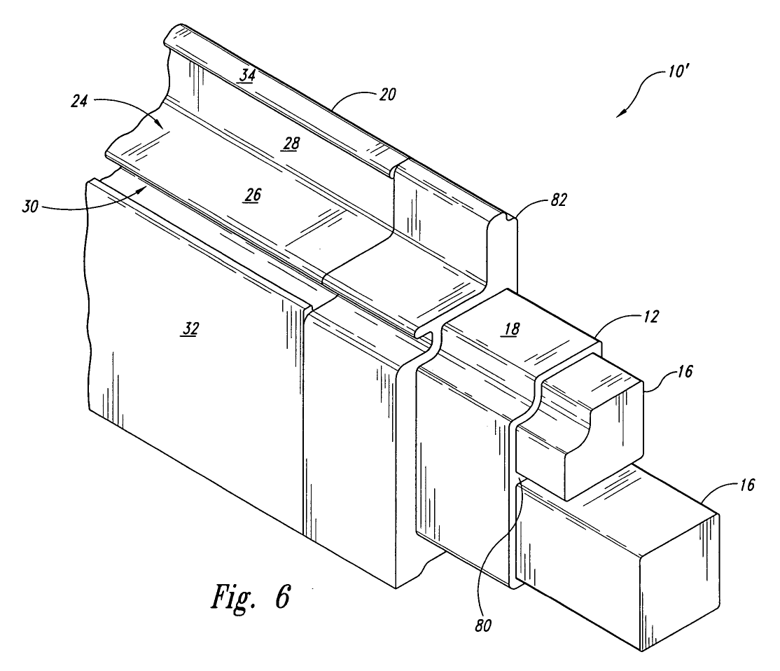

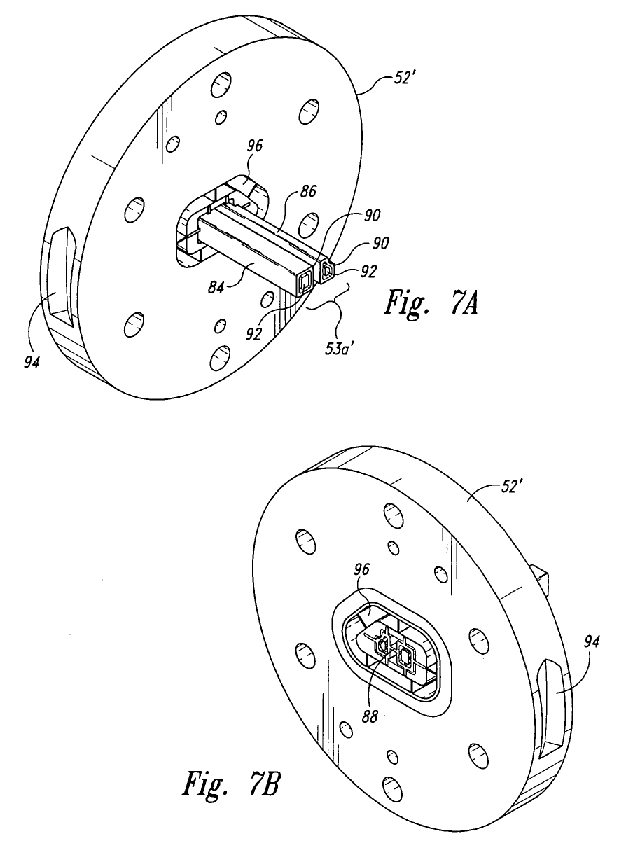

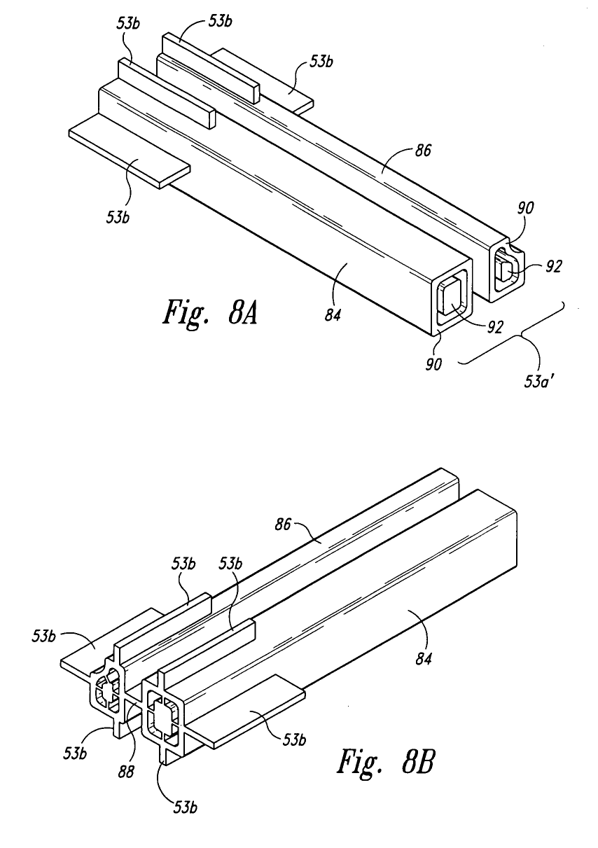

An alternate embodiment of the multi-composite polymer/wood fiber extrusion 10′ is shown in FIG. 6. This alternate embodiment employs a first thin wall, high density, hollow component 12, substantially identical to the corresponding component of FIG. 1. In addition, a second, low density foamed thermoplastic component 16 is employed which is also identical to that shown in FIG. 1, with a corresponding reference numeral. However, the extrusion 10′ of FIG. 6 has a first component 12, having a slightly different shape in profile, including an intermediate web portion 80, dividing the interior cavity 14 shown in FIG. 1 into twin cavities in which the second, low density foamed thermoplastic component 16 resides. The alternate embodiment 10′ also includes a thermoplastic cap 20 identical to that shown with respect to the first embodiment 10 shown in FIG. 1. However, the alternate embodiment 10′ is provided with a further, low density foamed thermoplastic component 82, intermediate the thermoplastic cap 20 and the exterior surface 18 of the thin wall, high density component 12. The further, low density foamed component 82 may be formed from an extrudate having a composition identical to the second, low density foamed thermoplastic component 16, as shown in Table II hereinabove.

The alternate embodiment 10′ of the multi-component extrusion shown in FIG. 6 is manufactured utilizing a modified form of the die assembly 40 shown in FIG. 2. In this alternate embodiment, the mandrel plate 52 is replaced with an alternate mandrel plate design 52′, shown in FIGS. 7a and 7b. In this alternate embodiment, the first mandrel 53(a)′ is provided with a first section 84 and a second section 86, interconnected by a fin 88. Each of the sections includes an outer, hollow mandrel 90 and an inner, floating mandrel. 92, having a solid cross-section. Each of the mandrels is supported by a plurality of fins, shown with respect to the first embodiment. In addition, the alternate embodiment of the mandrel plate 52′ is provided with a tertiary extrudate inlet 94, which is in fluid communication with an internal tertiary conduit 96 for introduction of a tertiary extrudate which will result in the further, low density foamed component 82, shown in FIG. 6. The tertiary extrudate may have the same formulation as shown in Table II with respect to the secondary extrudate 66 and second, low density foamed thermoplastic component 16 of the first embodiment 10.

Further alternate embodiments of the invention are contemplated. By way of example and not limitation, the capstock material 20 of alternate embodiment 10′ may be eliminated, and the tertiary extrudate which forms the further, low density foamed component 82 may be replaced with a formulation having a significant wood flour component and improved paintability characteristics resulting from the formulation illustrated in Table V, below, in which the principal thermoplastic component is Styrene Acrylonitrile (SAN) polymer resin.

TABLE V
SAN/Wood Flour Foamed Composite

| | PERCENT | | | |
|---|---|---|---|---|
| | (by | | | |
| INGREDIENT | weight) | SUPPLIER | CITY | STATE |
| SAN Resin | 70-90 | Kumho | | South |
| | | | | Korea |
| Wood Flour | 5-25 | American | Schofield | Wisconsin |
| | | Wood Fiber | | |
| ABS | 2-8 | GE | Morgantown | West |
| Modifier | | | | Virginia |
| Lubricant | 0.1-0.5 | Synpro | Cleveland | Ohio |
| Foaming | 0.5-3.0 | Color | Cleveland | Ohio |
| Agent | | Matrix | | |
| 80-428-1 | | | | |

In each of the above-described embodiments, all of the components exit the second capstocking die plate 58 in a molten (i.e. plastic) state and are introduced into a calibration unit (not shown) where the extrudate is cooled to shape. The resulting multi-component extrusion is preferably cooled further in a conventional cooling tank. Subsequent thereto the resulting extrudate enters a puller before it is cut to length by a saw subsequent to assembly into a window frame or the like.

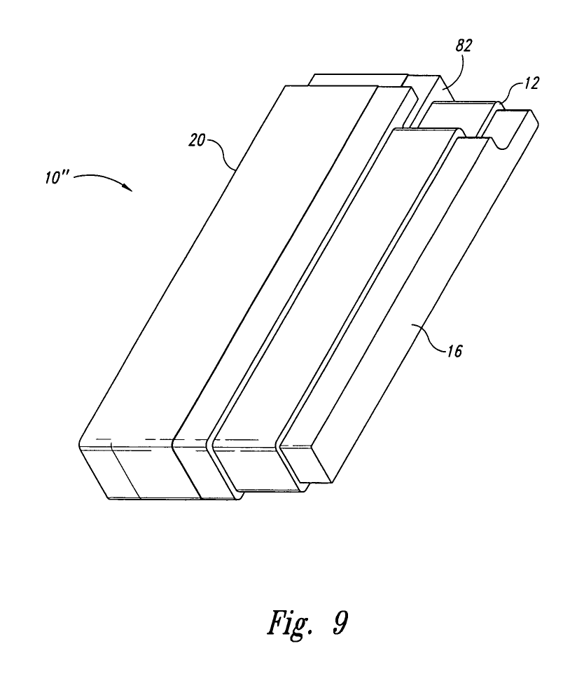

The above described methods and apparatus are also applicable for the production of decking and siding. By way of example, a third, alternate embodiment of the invention is generally indicated at reference numeral 10″ in FIG. 9. This embodiment employs a component structure substantially identical with respect to the second embodiment 10′ shown in FIG. 6 where like reference numerals refer to like structure. As will be appreciated by those of ordinary skill in the art, appropriate materials can be selected from those shown in Tables I through V above to achieve the desired macroscopic mechanical properties and weather resistance of the resulting multi-component extrusion 10″. Similarly, a decking material can be provided in the form shown with respect to the first preferred embodiment 10, shown in FIG. 1. In this alternate embodiment the cross-sectional shape of the extrusion is substantially identical to decking in the form of standard dimensional lumber wherein the multi-component composite decking extrusion has a foam composite core shown at reference numeral 16 in FIG. 1, surrounded by a composite shell core corresponding to reference numeral 12 of FIG. 1, and a cap corresponding to reference numeral 20 in FIG. 1.

In view of the above, the invention is not to be limited by the above disclosure but is to be determined in scope by the claims which follow.

I claim:

1. A multi-component, longitudinally continuous extrusion suitable for use in the fenestration, decking and remodeling industries, comprising:
a first, high density composite member consisting of a thermoplastic component and a cellulosic fiber component extruded from a primary extruder into an extrusion die, wherein the first member has inner and outer sidewalls defining a high density, thin wall extrusion having at least one enclosed, hollow interior compartment; and,
a second, low density foamed member consisting of a foamed thermoplastic polymer, coextruded with the first member in a molten state from a secondary extruder into the extrusion die so as to be laterally coextensive with and molecularly bonded to one of the sidewalls of the first member.

2. The multi-component, longitudinally continuous extrusion of claim 1, wherein the thermoplastic component of the first high density member has polyvinyl chloride as a principle component by weight.

3. The multi-component, longitudinally continuous extrusion of claim 1, wherein the foamed thermoplastic component of the second member has a substantial cellulosic fiber content.

4. The multi-component, longitudinally continuous extrusion of claim 3, wherein the foamed thermoplastic component has polyvinyl chloride as a principle component by weight.

5. The multi-component, longitudinally continuous extrusion of claim 3, wherein the foamed thermoplastic component has styrene acrylonitrile as a principle component by weight.

6. The multi-component, longitudinally continuous extrusion of claim 1, wherein the second member is laterally adjacent to, and longitudinally coextensive with the inner sidewall of the first high density member.

7. The multi-component, longitudinally continuous extrusion of claim 1, wherein the second member is laterally adjacent to and longitudinally coextensive with the outer sidewall of the first high density member.

8. The multi-component, longitudinally continuous extrusion of claim 1, wherein the second member is laterally adjacent to and longitudinally coextensive with both the inner and outer sidewalls of the first high density member.

9. The multi-component, longitudinally continuous extrusion of claim 1, including a third member consisting of a thermoplastic cap laterally adjacent to and coextensive with a laterally outermost one of the first and second members of the multi-component extrusion, wherein the thermoplastic cap is coextruded from a tertiary extruder into the extrusion die substantially simultaneously with the first and second members so as to be molecularly bonded with the laterally outermost member.

10. The multi-component, longitudinally continuous extrusion of claim 9, wherein the extrusion defines left hand and right hand sides, and wherein the thermoplastic cap has a highly weatherable thermoplastic polymer on the left hand side and a highly paintable thermoplastic polymer on the right hand side.

11. The multi-component, longitudinally continuous extrusion of claim 10, wherein the highly weatherable thermoplastic polymer has polyvinyl chloride as a principle component by weight, and wherein the highly paintable thermoplastic polymer has acrylic styrene acrylonitrile (ASA) as a principle component by weight.

12. A multi-plate extrusion die of the type having a plurality of die plates sequentially positioned so as to define upstream and downstream directions, comprising:
an introductory plate generally defining a primary aperture for passage therethrough of a primary extrudate, the primary aperture extending longitudinally through substantially each die plate of the extrusion die;
a mandrel plate downstream of the introductory plate and fluidly connected thereto for receipt of the primary extrudate and a secondary extrudate, having a first elongated mandrel substantially suspended therein by first support means for supporting the first mandrel in a spaced apart relationship within the primary aperture, wherein the first mandrel is substantially hollow and has a second mandrel substantially suspended therein by second support means for supporting the second mandrel in a spaced apart relationship within the first mandrel so as to form an elongated hollow, interstitial void between the first and second mandrels; and,
a secondary plate positioned between the introductory and mandrel plates having means for introducing the second extrudate into the interstitial void, whereby an elongated final extrudate having at least two different longitudinally continuous, molecularly bonded thermoplastic components can exit the mandrel plate.

13. The multi-plate extrusion die of claim 12, including a capstock plate, positioned downstream of the mandrel plate, for adding a third extrudate in the form of a capstock to the final extrudate.

14. The multi-plate extrusion die of claim 12, wherein the first and second support means are elongated, tapered fins having a decreasing thickness from the upstream direction to the downstream direction.

15. A method of making a multi-component, longitudinally continuous extrusion suitable for use in the fenestration, decking and remodeling industries with a multi-plate extrusion die of the type having a plurality of die plates sequentially positioned so as to define upstream and downstream directions, comprising the steps of:
preparing a thermoplastic primary extrudate and a thermoplastic secondary extrudate;
introducing the primary extrudate in a molten state into an introductory plate generally defining a primary aperture for passage therethrough of the primary extrudate, wherein the primary aperture extends longitudinally through substantially each die plate of the extrusion die;
positioning a mandrel plate downstream of and fluidly connected to the introductory plate, wherein the mandrel plate has a first elongated mandrel suspended in a spaced apart relationship within the primary aperture and wherein the first mandrel is substantially hollow and has a second mandrel substantially suspended therein in a spaced apart relationship within the first mandrel so as to form an elongated, hollow, interstitial void between the first and second mandrels; and,
introducing the secondary extrudate in a molten state into the interstitial void, whereby an elongated final extrudate having at least two different longitudinally continuous, molecularly bonded thermoplastic components exit the mandrel plate.

16. The method of claim 15, wherein the first extrudate is prepared so as to substantially consist of a thermoplastic component and a cellulosic fiber component, and wherein the second extrudate is prepared so as to substantially consist of a foamed thermoplastic polymer.

17. The method of claim 0.16, wherein the second extrudate includes a substantial cellulosic component.

18. The method of claim 15, including the step of providing a third thermoplastic capstock extrudate, positioning a capstock plate downstream of the mandrel plate, introducing the third extrudate in a molten state to an exterior surface of the final extrudate so as to form a cap.

19. The method of claim 18, wherein the final extrudate defines left hand and right hand sides, including the steps of simultaneously applying two different types of thermoplastic capstocks to the final extrusion, one of the thermoplastic capstock materials consisting of a highly weatherable thermoplastic polymer on the left hand side and another of the thermoplastic capstock materials consisting of a highly paintable thermoplastic polymer on the right hand side.
